(19) United States
(12) Patent Application Publication
(10) Pub. No.: US 2024/0135245 A1
(43) Pub. Date: Apr. 25, 2024

(54) COMPUTER-READABLE RECORDING MEDIUM STORING OUTPUT PROGRAM, OUTPUT METHOD, AND INFORMATION PROCESSING APPARATUS

(71) Applicant: Fujitsu Limited, Kawasaki-shi (JP)

(72) Inventor: Mariko KASE, Yokohama (JP)

(73) Assignee: Fujitsu Limited, Kawasaki-shi (JP)

(21) Appl. No.: 18/238,532

(22) Filed: Aug. 27, 2023

(30) Foreign Application Priority Data
Oct. 23, 2022 (JP) 2022-170107

(51) Int. Cl. G06N 20/00

(52) U.S. Cl. CPC G06N 20/00

(57) ABSTRACT

A non-transitory computer-readable recording medium storing an output program causing a computer to execute a process, the process includes extracting an operation description related to a data operation for input data to a machine learning program, from the machine learning program, determining an extraction condition of target data to be operated in the data operation, based on the extracted operation description, extracting the target data which satisfies the determined extraction condition, from the input data, and outputting sampling data which includes the extracted target data.

### CROSS-REFERENCE TO RELATED APPLICATION

This application is based upon and claims the benefit of priority of the prior Japanese Patent Application No. 2022-170107, filed on Oct. 24, 2022, the entire contents of which are incorporated herein by reference.

### FIELD

The embodiments discussed herein are related to a computer-readable recording medium storing an output program, an output method, and an information processing apparatus.

### BACKGROUND

Automated machine learning (AutoML) for automatically generating an appropriate machine learning program by using data and a task as inputs is actively being developed at present. For realizing AutoML, it is important to accumulate useful components (code snippets) in a large number of existing machine learning programs. Accordingly, a process of extracting a code snippet from a plurality of existing machine learning programs is performed.

When the code snippet is extracted from the machine learning program, dynamic slicing is performed in which a code is dynamically executed to extract a dependency relationship between commands. By dynamic slicing, for example, a command group related to a predetermined variable is extracted from the machine learning program including a plurality of commands. The extracted command group is output as the code snippet.

As a technique useful for analysis of a program such as the machine learning program, for example, an extraction method of accurately extracting a call relationship between programs is proposed.
Japanese Laid-open Patent Publication No. 2021-165902 is disclosed as related art.

### SUMMARY

According to an aspect of the embodiments, a non-transitory computer-readable recording medium storing an output program causing a computer to execute a process, the process includes extracting an operation description related to a data operation for input data to a machine learning program, from the machine learning program, determining an extraction condition of target data to be operated in the data operation, based on the extracted operation description, extracting the target data which satisfies the determined extraction condition, from the input data, and outputting sampling data which includes the extracted target data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an output method of sampling data according to a first embodiment;

FIG. 2 is a diagram illustrating an example of a system configuration according to a second embodiment;

FIG. 3 is a diagram illustrating an example of hardware of a machine learning support apparatus used in the present embodiment;

FIG. 4 is a block diagram illustrating a function of the machine learning support apparatus;

FIG. 5 is a diagram illustrating an example of table data;

FIG. 6 is a diagram illustrating an example of a machine learning program;

FIG. 7 is a diagram illustrating an example of a procedure of a data extraction process;

FIG. 8 is a diagram illustrating an example of a path extraction process;

FIG. 9 is a flowchart illustrating an example of a procedure of the path extraction process;

FIG. 10 is a diagram illustrating an example of a data sampling condition search;

FIG. 11 is a diagram illustrating an example of a data sampling condition;

FIG. 12 is a flowchart illustrating an example of a procedure of a data sampling condition search process;

FIG. 13 is a diagram illustrating an example of data sampling;

FIG. 14 is a flowchart illustrating an example of a procedure of a data sampling process;

FIG. 15 is a block diagram illustrating an example of a function of a machine learning support apparatus according to a third embodiment;

FIG. 16 is a flowchart illustrating an example of a procedure of a data extraction process according to the third embodiment;

FIG. 17 is a flowchart illustrating an example of a procedure of a data sampling process according to the third embodiment;

FIG. 18 is a diagram illustrating another example of the machine learning program;

FIG. 19 is a diagram illustrating an example of a data frame name of each of a plurality of machine learning programs;

FIG. 20 is a diagram illustrating an example of a data sampling condition search of each of the plurality of machine learning programs;

FIG. 21 is a diagram illustrating an example of a data sampling condition of each of the plurality of machine learning programs and an OR condition of the data sampling condition;

FIG. 22 is a diagram illustrating another example of the data sampling; and

FIG. 23 is a diagram illustrating an example of a machine learning program in which a plurality of pieces of table data are set as input data.

### DESCRIPTION OF EMBODIMENTS

Since the machine learning program is actually executed in dynamic slicing, it takes longer to execute the process as the amount of data used for machine learning is increased. For example, in a case where there is a large amount of training data to be used for model generation by using a machine learning program, when dynamic slicing of the machine learning program is performed by using the training data, it takes a long time to perform the process.

Accordingly, it is conceivable to reduce the data amount of training data to be input before dynamic slicing is executed. For example, it is considered that, by reducing the data amount of the training data to be used for the machine learning, a time taken to execute the machine learning is reduced, and as a result, an execution time of the dynamic slicing is also reduced.

Meanwhile, in dynamic slicing in which an existing machine learning program has to be reliably executed, for example, in a method of randomly deleting training data, there is a risk in which execution of the dynamic slicing is hindered by reduction of the training data.

Hereinafter, the embodiments of techniques capable to reduce the amount of data used for dynamic slicing will be described with reference to the drawings. Each embodiment may be implemented by combining a plurality of embodiments within a range without contradiction.

### First Embodiment

A first embodiment is a sampling data output method capable of reducing the data amount of sampling data used for dynamic slicing.

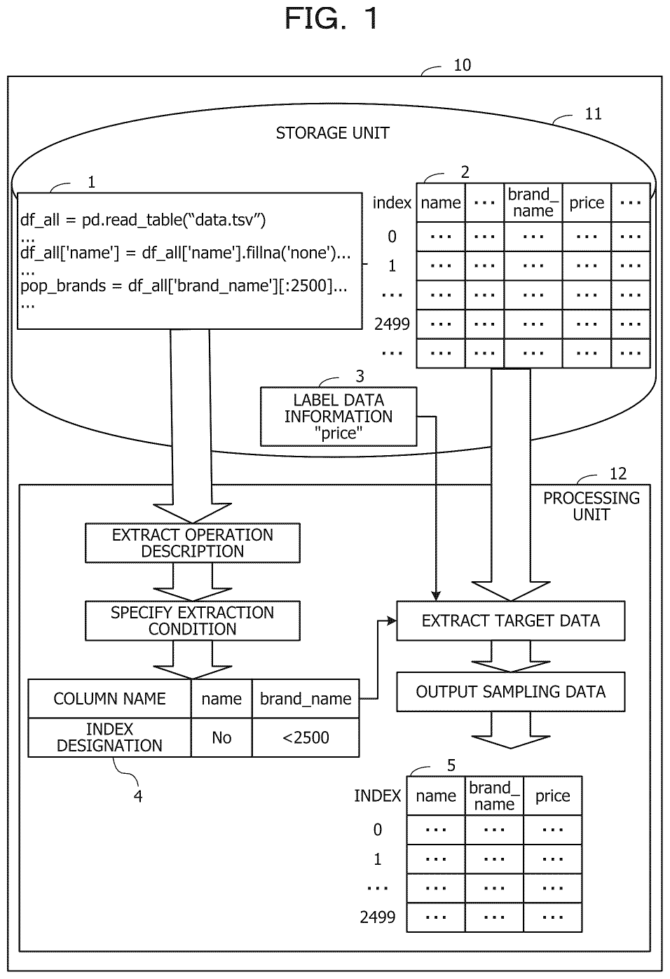

FIG. 1 illustrates an example of an output method of sampling data according to the first embodiment. FIG. 1 illustrates an information processing apparatus 10 for executing the output method of the sampling data. For example, by executing a predetermined output program, the information processing apparatus 10 is able to execute the output method of the sampling data.

The information processing apparatus 10 includes a storage unit 11 and a processing unit 12. The storage unit 11 is, for example, a storage device or a memory included in the information processing apparatus 10. The processing unit 12 is, for example, a processor or an arithmetic circuit included in the information processing apparatus 10.

The storage unit 11 stores a machine learning program 1 as a target of dynamic slicing, input data 2 to the machine learning program 1, and label data information 3 for designating label data of teaching data in machine learning using the machine learning program 1.

The processing unit 12 extracts an operation description related to a data operation on the input data 2 from the machine learning program 1. For example, the processing unit 12 analyzes the machine learning program 1, and specifies a DataFrame name “df_all”. The processing unit 12 extracts a function related to the data operation of DataFrame from the machine learning program 1. In the example illustrated in FIG. 1, “df_all[‘name’].fillna (‘none’) . . . ”, “df_all[‘brand_name’][:2500] . . . ”, and the like are extracted.

Next, the processing unit 12 determines an extraction condition 4 for target data to be operated in the data operation, based on the extracted operation description. For example, the processing unit 12 specifies a column name of a column storing the target data in the input data 2 in a table format from the extracted operation description, and includes, in the extraction condition 4, a condition of being stored in the column having the specified column name. The processing unit 12 includes, in the extraction condition 4, a condition of being stored in a column having the specified column name of a row corresponding to an index designated in the extracted operation description. In the extraction condition 4 of the example illustrated in FIG. 1, the extraction condition 4 indicates that the data is data of columns having the column names “name” and “brand_name” in a row having an index less than 2500.

From the input data 2, the processing unit 12 extracts target data satisfying the determined extraction condition 4. At this time, the processing unit 12 may extract, from the input data 2, for example, the target data satisfying the determined extraction condition 4 and label data, which is data to be predicted in machine learning using the machine learning program 1. The label data information 3 indicates which data in the input data 2 is to be label data. In the example illustrated in FIG. 1, data having a column name “price” is label data.

The processing unit 12 outputs sampling data 5 including the extracted target data. For example, the processing unit 12 deletes non-target data, which does not satisfy the extraction condition 4, from the input data 2. In a case where the label data is also extracted, the processing unit 12 deletes data, which does not satisfy the extraction condition 4 and is not label data, from the input data 2.

The processing unit 12 outputs the sampling data 5 including the extracted target data. In the example illustrated in FIG. 1, the sampling data 5 having data of columns “name”, “brand_name”, and “price” in 2500 rows of indices of 0 to 2499 is extracted.

In dynamic slicing, a code of a machine learning program is executed, and a process of extracting a dependency relationship between commands is performed based on an execution result. At this time, when data of an operation target of the machine learning program does not exist in input data, the machine learning program may not be executed. Since the machine learning program is not executed correctly, the dependency relationship between the commands may not be extracted correctly. For example, when the data of the operation target is deleted in the machine learning program due to data reduction, the dynamic slicing may not be correctly executed.

In the above description, the sampling data 5 output by the processing unit 12 includes data of an operation target in the machine learning program 1. Therefore, when dynamic slicing is performed by executing the machine learning program 1 using the sampling data 5 as input data, a process executed by the machine learning program 1 is correctly executed according to a code, and appropriate dynamic slicing may be performed. Since the amount of data of the sampling data 5 is smaller than the amount of data of the input data 2, the dynamic slicing may be performed more efficiently (in a shorter execution time) than a case where input data on which data reduction is not performed is used.

For example, since the sampling data 5 includes data of a column of an operation target in the machine learning program 1, when the machine learning program 1 is executed, an operation on data of a specific column is correctly executed without being skipped due to data shortage. As a result, accurate dynamic slicing may be performed.

In a case where an index of the data of the operation target is designated in the operation description, the processing unit 12 extracts only the data of the index from the input data. Accordingly, unnecessary data is not extracted, and only the minimum data is extracted. As a result, the data amount of the sampling data 5 is reduced. For example, the processing unit 12 may generate the sampling data 5 from which unnecessary data is deleted by deleting non-target data, which does not satisfy the extraction condition 4, from the input data 2.

In a case where the index of the operation target is not designated in any operation description, for example, the processing unit 12 extracts data of N rows (N is a natural number) from the input data 2. N is set to as a small value as possible within a range in which the machine learning program may be executed correctly.

In a case where indices of operation targets are designated in a plurality of operation descriptions, for example, the processing unit 12 extracts data from a row of an index corresponding to a logical sum of the designated indices. Accordingly, by using the sampling data 5, it is possible to correctly execute a process according to all the operation descriptions for which the index is designated.

In a case where the machine learning program 1 is a program for supervised learning, label data is also used in addition to the data of the operation target. By also extracting the label data from the input data 2 and including the label data in the sampling data 5, it is possible to correctly execute the supervised learning based on the sampling data 5.

There is a case where there are a plurality of machine learning programs 1 that use the common input data 2, and dynamic slicing is performed on each of the machine learning programs 1. In this case, for example, the processing unit 12 may output the sampling data 5 for each of the plurality of machine learning programs 1. The processing unit 12 may generate one sampling data 5 for the plurality of machine learning programs 1.

For example, the processing unit 12 extracts, from each of the plurality of machine learning programs 1, an operation description for the input data 2 common to the plurality of machine learning programs 1. The processing unit 12 determines the extraction condition 4 for each of the plurality of machine learning programs 1. The processing unit 12 extracts target data satisfying any of a plurality of extraction conditions 4 corresponding to the plurality of machine learning programs 1 (data satisfying a condition of a logical sum of the plurality of extraction conditions 4) from the input data 2. Accordingly, it is possible to generate the sampling data 5 to be used in common to the plurality of machine learning programs 1.

As a result, it is possible to reduce the data amount of the sampling data 5 for executing dynamic slicing on the plurality of machine learning programs 1.

### Second Embodiment

A second embodiment is a machine learning support apparatus capable of efficiently executing automatic generation of a machine learning program with AutoML.

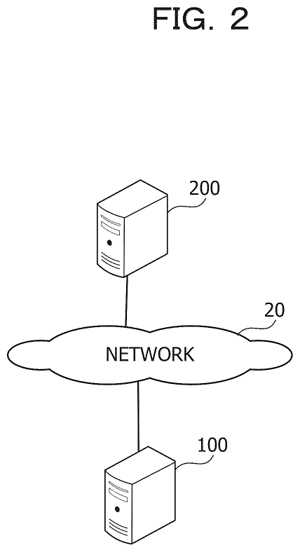

FIG. 2 is a diagram illustrating an example of a system configuration according to the second embodiment. A machine learning support apparatus 100 is coupled to a server 200 via a network 20. The servers 200 is a computer that holds data, which is usable as training data. The machine learning support apparatus 100 is a computer that generates a machine learning program for performing machine learning by using the data stored in the server 200 as the training data.

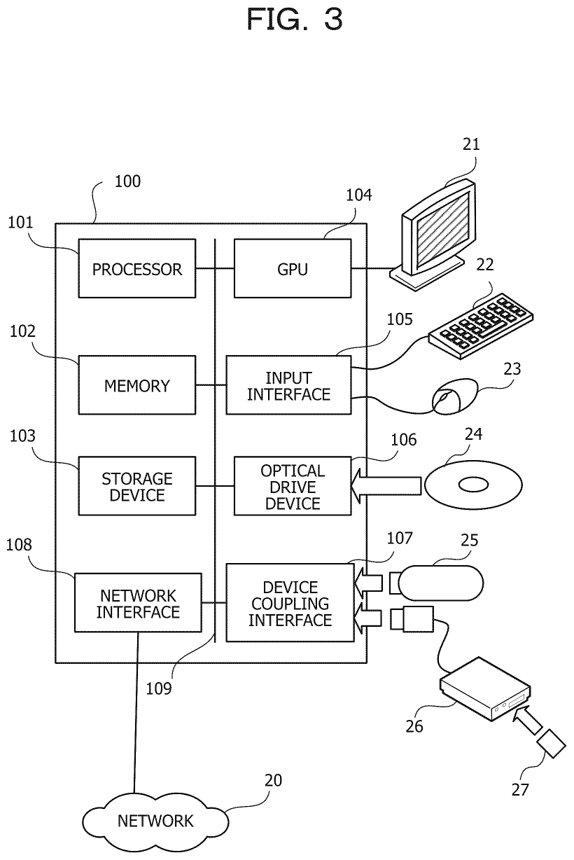

FIG. 3 is a diagram illustrating an example of hardware of a machine learning support apparatus used in the present embodiment. The machine learning support apparatus 100 is entirely controlled by a processor 101. A memory 102 and a plurality of peripheral devices are coupled to the processor 101 via a bus 109. The processor 101 may be a multiprocessor. The processor 101 is, for example, a central processing unit (CPU), a microprocessor unit (MPU), or a digital signal processor (DSP). At least a part of a function realized by the processor 101 executing a program may be realized by an electronic circuit such as an application-specific integrated circuit (ASIC), and a programmable logic device (PLD).

The memory 102 is used as a main storage device of the machine learning support apparatus 100. The memory 102 temporarily stores at least a part of an operating system (OS) program or an application program to be executed by the processor 101. The memory 102 stores various types of data to be used for a process by the processor 101. As the memory 102, for example, a volatile semiconductor storage device such as a random-access memory (RAM) is used.

The peripheral devices coupled to the bus 109 include a storage device 103, a graphics processing unit (GPU) 104, an input interface 105, an optical drive device 106, a device coupling interface 107, and a network interface 108.

The storage device 103 writes and reads data electrically or magnetically to a built-in recording medium. The storage device 103 is used as an auxiliary storage device of the machine learning support apparatus 100. The storage device 103 stores an OS program, an application program, and various types of data. As the storage device 103, for example, a hard disk drive (HDD) or a solid-state drive (SSD) may be used.

The GPU 104 is an arithmetic device that performs an image process, and is also referred to as a graphic controller. A monitor 21 is coupled to the GPU 104. The GPU 104 displays images on a screen of the monitor 21 in accordance with a command from the processor 101. As the monitor 21, a display device, a liquid crystal display device, or the like using organic electro luminescence (EL) is used.

A keyboard 22 and a mouse 23 are coupled to the input interface 105. The input interface 105 transmits to the processor 101 signals transmitted from the keyboard 22 and the mouse 23. The mouse 23 is an example of a pointing device, and other pointing devices may be used. An example of the other pointing device includes a touch panel, a tablet, a touch pad, a track ball, or the like.

The optical drive device 106 reads data recorded in an optical disc 24 or writes data to the optical disc 24 by using laser light or the like. The optical disc 24 is a portable-type recording medium in which data is recorded such that the data is readable by reflection of light. Examples of the optical disc 24 include a Digital Versatile Disc (DVD), a DVD-RAM, a compact disc read-only memory (CD-ROM), a CD-recordable (CD-R), a CD-rewritable (CD-RW), and the like.

The device coupling interface 107 is a communication interface for coupling the peripheral device to the machine learning support apparatus 100. For example, a memory device 25 or a memory reader and writer 26 may be coupled to the device coupling interface 107. The memory device 25 is a recording medium in which the function of communication with the device coupling interface 107 is provided. The memory reader and writer 26 is a device that writes data to a memory card 27 or reads data from the memory card 27. The memory card 27 is a card-type recording medium.

The network interface 108 is coupled to the network 20. The network interface 108 transmits and receives data to and from another computer or a communication device via the network 20. The network interface 108 is, for example, a wired communication interface that is coupled to a wired communication device such as a switch or a router by a cable. The network interface 108 may be a wireless communication interface that is coupled, by radio waves, to and communicates with a wireless communication device such as a base station or an access point.

With the above hardware, the machine learning support apparatus 100 may realize a process function in the second embodiment. The information processing apparatus 10 described in the first embodiment may also be realized by hardware in the same manner as the hardware of the machine learning support apparatus 100 illustrated in FIG. 3.

The machine learning support apparatus 100 realizes the process function of the second embodiment by executing, for example, a program recorded in a computer-readable recording medium. The program in which process contents to be executed by the machine learning support apparatus 100 are described may be recorded in various recording media. For example, the program to be executed by the machine learning support apparatus 100 may be stored in the storage device 103. The processor 101 loads at least a part of the program in the storage device 103 to the memory 102, and executes the program. The program to be executed by the machine learning support apparatus 100 may be recorded on a portable-type recording medium such as the optical disc 24, the memory device 25, or the memory card 27. The program stored in the portable-type recording medium may be executed after the program is installed in the storage device 103 under the control of the processor 101, for example. The processor 101 may read the program directly from the portable-type recording medium and execute the program.

The machine learning support apparatus 100 automatically generates a machine learning program with AutoML by using a code snippet generated by dynamic slicing. For efficient execution of dynamic slicing, the machine learning support apparatus 100 performs, before the dynamic slicing, a process of reducing the amount of data to be input at a time of execution of the machine learning program of a target of the dynamic slicing. By reducing the amount of data to be input, the dynamic slicing may be efficiently executed.

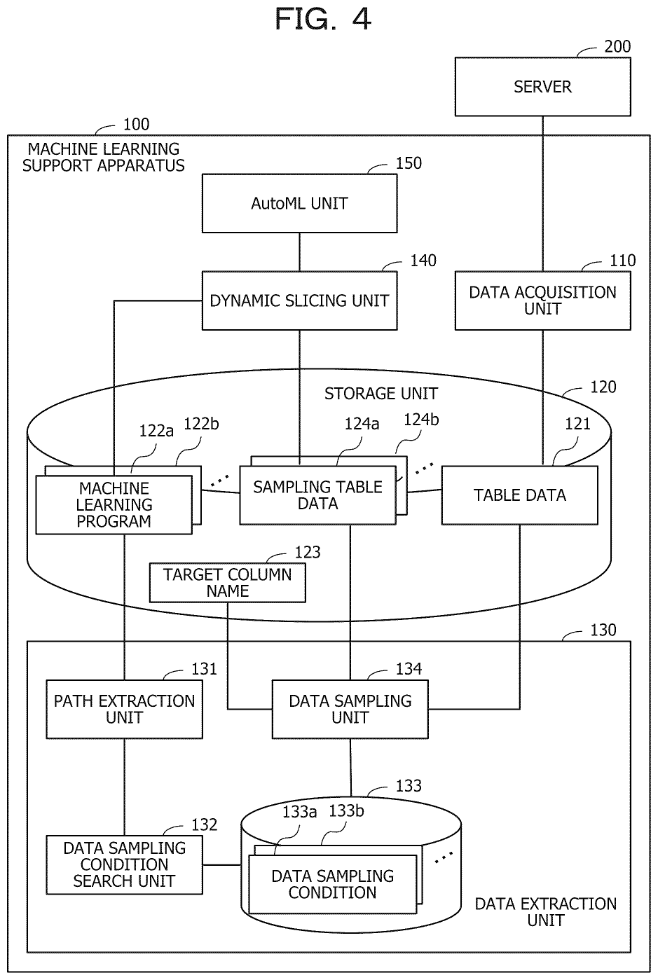

FIG. 4 is a block diagram illustrating a function of a machine learning support apparatus. The machine learning support apparatus 100 includes a data acquisition unit 110, a storage unit 120, a data extraction unit 130, a dynamic slicing unit 140, and an AutoML unit 150.

The data acquisition unit 110 acquires data, which is usable as teaching data for machine learning, from the server 200. For example, the data acquisition unit 110 acquires table data 121 from the server 200, and stores the acquired table data 121 in the storage unit 120.

The storage unit 120 stores data to be used for automatic generation of a machine learning program. For example, the storage unit 120 stores the table data 121, a plurality of machine learning programs 122a, 122b, . . . , a target column name 123, and a plurality of pieces of sampling table data 124a, 124b, . . . . The table data 121 is data in a table format used as training data for machine learning. The machine learning programs 122a, 122b, . . . are machine learning programs, which are targets for dynamic slicing. The target column name is a name of a column in which data to be used as label data in a machine learning program to be generated is registered, among columns of the table data 121. The sampling table data 124a, 124b, . . . is table data generated by extracting minimum data for executing dynamic slicing from the table data 121, according to each of the machine learning programs 122a, 122b, . . . .

For each of the machine learning programs 122a, 122b, . . . , the data extraction unit 130 extracts, from the table data 121, minimum data for executing dynamic slicing, and generates the sampling table data 124a, 124b, . . . . The data extraction unit 130 includes a path extraction unit 131, a data sampling condition search unit 132, a data sampling condition accumulation unit 133, and a data sampling unit 134.

From each of the machine learning programs 122a, 122b, . . . , the path extraction unit 131 extracts a path indicating a dependency relationship between data processes related to “pandas.DataFrame( )”. For example, the path extraction unit 131 extracts a path by using a function “pandas.DataFrame” used to read table data, as a starting point. As the path extraction method, for example, a program extraction method by a rule base, an abstract syntax tree (AST), or the like may be used.

For each of the machine learning programs 122a, 122b, . . . , the data sampling condition search unit 132 searches for a minimum data condition for executing dynamic slicing, based on the path extracted by the path extraction unit 131. The data sampling condition search unit 132 stores the data sampling conditions 133a, 133b, . . . for each of the machine learning programs 122a, 122b, . . . in the data sampling condition accumulation unit 133.

The data sampling condition accumulation unit 133 stores the data sampling conditions 133a, 133b, . . . . For example, the data sampling condition accumulation unit 133 is provided in a storage region in the memory 102 managed by the data extraction unit 130.

Based on the data sampling conditions 133a, 133b, . . . , the data sampling unit 134 extracts data from the table data 121. At this time, the data sampling unit 134 adds data of a column indicated by the target column name 123 to the data to be extracted. Based on the extracted data, the data sampling unit 134 generates the sampling table data 124a, 124b, . . . , and stores the sampling table data 124a, 124b, . . . in the storage unit 120.

For each of the machine learning programs 122a, 122b, . . . , the dynamic slicing unit 140 executes dynamic slicing by using corresponding sampling table data. For example, the dynamic slicing unit 140 receives sampling table data corresponding to a specific machine learning program as an input, and executes the machine learning program. The dynamic slicing unit 140 extracts a command group related to a predetermined variable as a code snippet. The dynamic slicing unit 140 transmits the extracted code snippet to the AutoML unit 150.

By using the code snippet acquired from the dynamic slicing unit 140, the AutoML unit 150 automatically generates a machine learning program according to a designated task.

A line coupling each element illustrated in FIG. 4 represents a part of a communication path, and other communication paths other than the communication path may also be set. For example, a function of each element illustrated in FIG. 4 may be realized by causing a computer to execute a program module corresponding to the element.

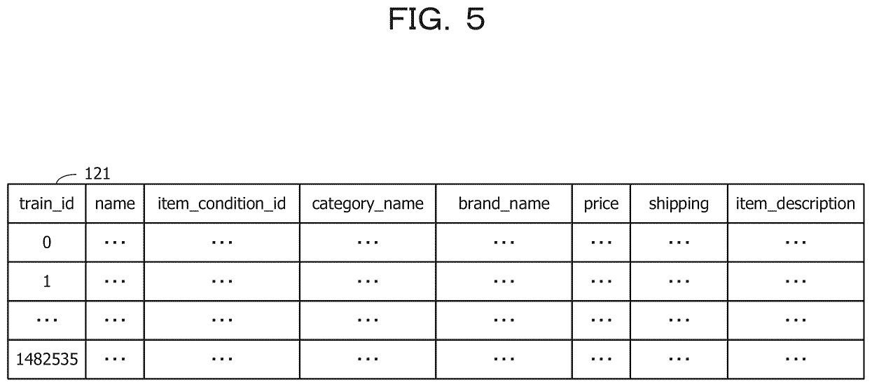

FIG. 5 is a diagram illustrating an example of table data. The table data 121 illustrated in FIG. 5 is stored in a file in a tab separated values (TSV) format having a file name “data.tsv”, for example. A project ID “001” is set in the table data 121. The number of rows of the table data 121 is “1,482,536”.

The number of columns of the table data 121 is “8”. Column names of the respective columns are “train_id, name, item_condition_id, category_name, brand_name, price, shipping, item_description”, respectively.

Data of the column name “train_id” of each row is a row name (index) of the row. A number in ascending order from 0 is given to each row as the index.

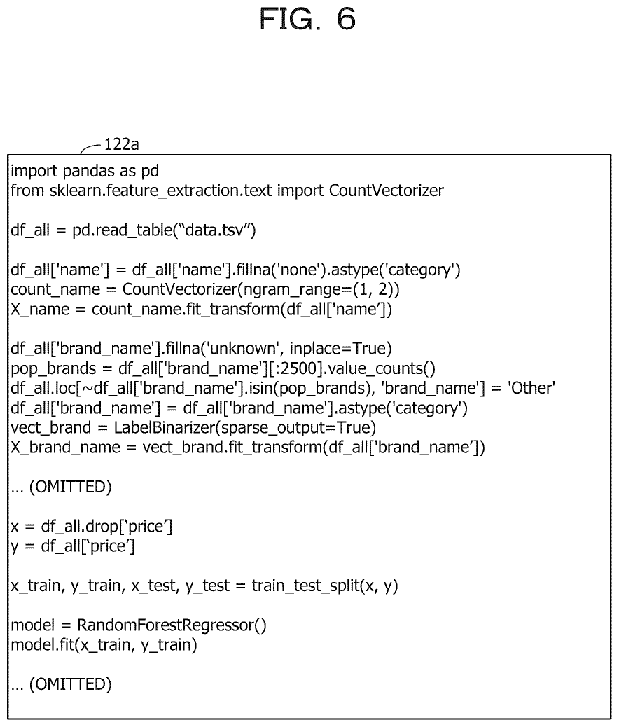

FIG. 6 illustrates an example of a machine learning program. A program of executing machine learning by using the table data 121 with the file name “data.tsv” as an input is described in the machine learning program 122a.

In the machine learning support apparatus 100, when the data acquisition unit 110 acquires the table data 121 from the server 200, the data extraction unit 130 performs a data extraction process according to each of the machine learning programs 122a, 122b, . . . from the table data 121.

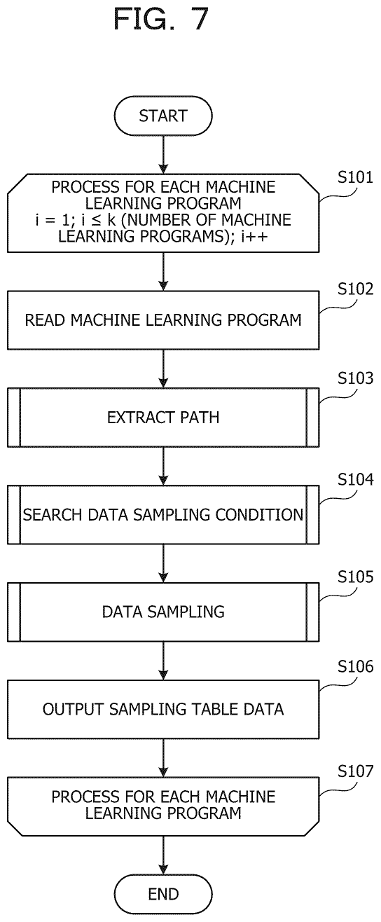

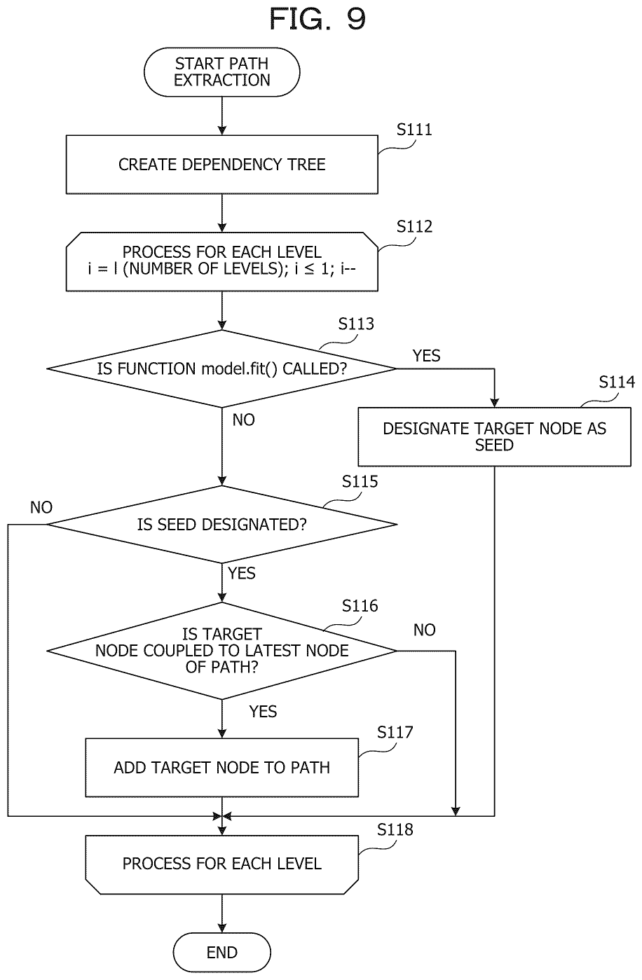

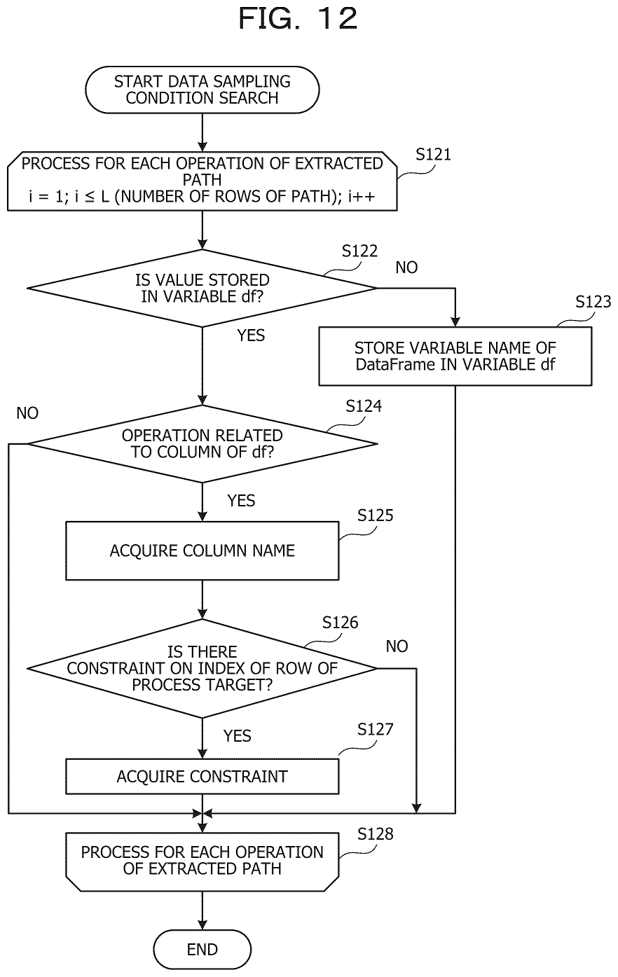

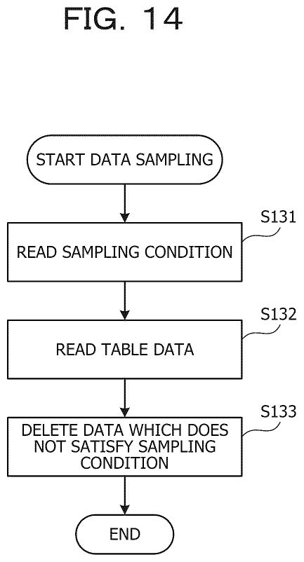

FIG. 7 is a diagram illustrating an example of a procedure of the data extraction process. Hereinafter, the processes illustrated in FIG. 7 will be described in order of operation numbers.

[operation S101] The data extraction unit 130 executes the processes in operations S102 to S106 on each machine learning program. For example, in a case where the number of machine learning programs is k (k is a natural number), the data extraction unit 130 starts the process from the first machine learning program, and repeats the process until the process on the k-th machine learning program is ended.

[operation S102] The data extraction unit 130 reads one of the machine learning programs, on which the data extraction process is not executed, from the storage unit 120.

[operation S103] The path extraction unit 131 of the data extraction unit 130 performs a path extraction process for a dependency relationship of a data process in the read machine learning program. Details of the path extraction process will be described below (see FIG. 9).

[operation S104] The data sampling condition search unit 132 performs a data sampling condition search process. By the data sampling condition search process, a data sampling condition for data sampling corresponding to the machine learning program as a process target is generated. For example, the data sampling condition search unit 132 specifies an instance of pandas.DataFrame as an operation target based on a path extracted by the path extraction unit 131. Based on the instance of DataFrame, the data sampling condition search unit 132 determines the data sampling condition. Details of the data sampling condition search process will be described below (see FIG. 12).

[operation S105] Based on the generated data sampling condition, the data sampling unit 134 performs a data sampling process from the table data 121. Details of the data sampling process will be described below (see FIG. 14).

[operation S106] The data sampling unit 134 outputs sampling table data generated in the data sampling process. For example, the data sampling unit 134 stores the sampling table data in the storage unit 120.

[operation S107] After the processes in operations S102 to S106 are completed for all the machine learning programs 122a, 122b, . . . , the data extraction unit 130 ends the data extraction process.

Next, the path extraction process will be described in detail.

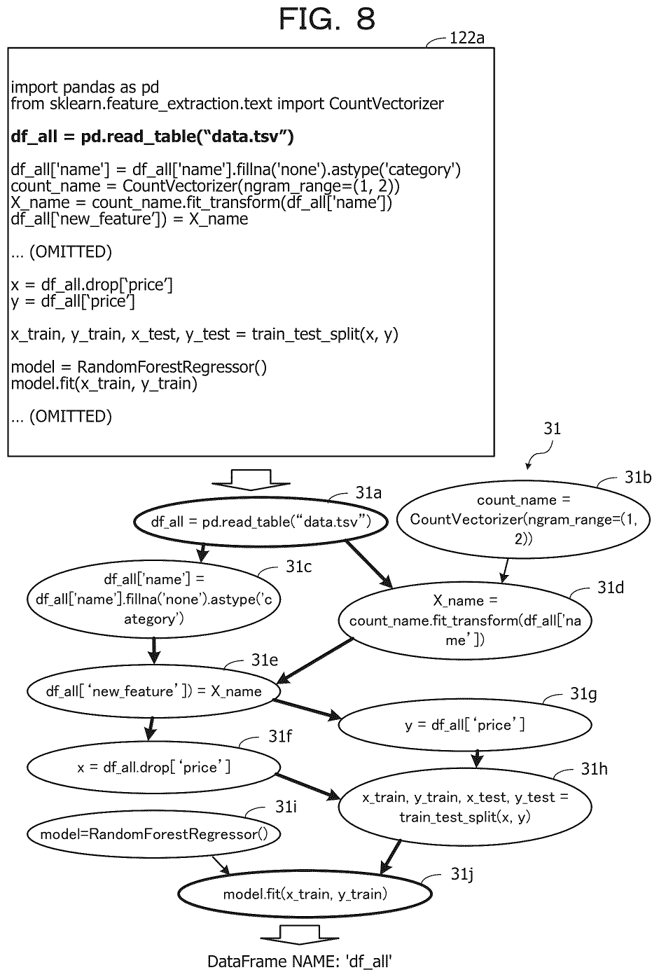

FIG. 8 is a diagram illustrating an example of the path extraction process. FIG. 8 illustrates an example of searching for an instance of pandas.DataFrame from the machine learning program 122a. In order to extract a path, the path extraction unit 131 generates, for example, a dependency tree 31 indicating a dependency relationship between processes of the machine learning program 122a. The dependency tree 31 includes nodes 31a to 31j corresponding to the respective processes, and the dependency relationship between the processes is indicated by an arrow coupling the nodes 31a to 31j. An arrow indicates that a process of a node at a destination of the arrow depends on a process of a node at a source of the arrow. Hereinafter, it is assumed that the node at the source of the arrow is on an upper side of the node at the destination of the arrow.

By using the node 31j corresponding to a function model.fit( ) as a starting point (seed), the path extraction unit 131 traces a dependency relationship of data in the dependency tree 31 upward. In the example illustrated in FIG. 8, the machine learning program 122a includes “model. fit(x_train, y_train)” of the function model.fit( ) From this function model.fit( ) it is seen that data to be used for machine learning is “x_train, y_train”. Accordingly, the path extraction unit 131 traces a dependency relationship of “x_train, y_train” upward, in the dependency tree 31.

The dependency relationship using the data “x_train, y_train” as a starting point is indicated by a thick line arrow in the dependency tree 31 in FIG. 8. A coupling relationship between nodes with which the dependency relationship from the data “x_train, y_train” may be traced is a path related to pandas.DataFrame( ).

By tracing the dependency relationship of the data indicated by the path upward to reach a node, it is possible to specify an instance of pandas.DataFrame. By tracing the dependency relationship in the example illustrated in FIG. 8, “df_all=pd.read_table(“data.tsv”)” is reached. In this case, “DataFrame name: df_all” is specified, as the instance of pandas.DataFrame.

Hereinafter, a procedure of the path extraction process will be described in detail.

FIG. 9 is a flowchart illustrating an example of the procedure of the path extraction process. Hereinafter, the processes illustrated in FIG. 9 will be described in order of operation numbers.

[operation S111] The path extraction unit 131 creates the dependency tree 31.

[operation S112] From a lower level of the dependency tree 31, the path extraction unit 131 executes the processes in operations S113 to S117 on a node of each level as a process target. For example, in a case where the number of levels in the dependency tree 31 is I, the path extraction unit 131 starts the process from a node in the l-th level (lowest level) from a high level, and moves the level one by one to the upper level. Until the process on the node in the first level is ended, the path extraction unit 131 repeats the processes.

[operation S113] The path extraction unit 131 determines whether or not a process indicated by a node (target node) in the process target level in the dependency tree 31 calls the function model.fit( ). In a case where the function model.fit( ) is called, the path extraction unit 131 shifts the process to operation S114. In a case where the function model.fit( ) is not called, the path extraction unit 131 shifts the process to operation S115.

[operation S114] The path extraction unit 131 designates a target node as a seed. The seed is a node serving as a starting point of a path to be extracted. At a time when the seed is designated, a node of the seed becomes the latest node of the path. After that, the path extraction unit 131 shifts the process to operation S118.

[operation S115] The path extraction unit 131 determines whether or not the seed is designated. In a case where the seed is designated, the path extraction unit 131 shifts the process to operation S116. In a case where the seed is not designated, the path extraction unit 131 shifts the process to operation S118.

[operation S116] The path extraction unit 131 determines whether or not the target node is coupled to the latest node of the path in the dependency tree 31. When the path is coupled to the latest node of the path, the path extraction unit 131 shifts the process to operation S117. When the path is not coupled to the latest node of the path, the path extraction unit 131 shifts the process to operation S118.

[operation S117] The path extraction unit 131 adds the target node as the latest node of the path.

[operation S118] After the process for each level is ended for the nodes of all the levels, the path extraction unit 131 ends the path extraction process.

After the path related to pandas.DataFrame( ) is extracted in the path extraction process, a search process for a data sampling condition is performed by the data sampling condition search unit 132.

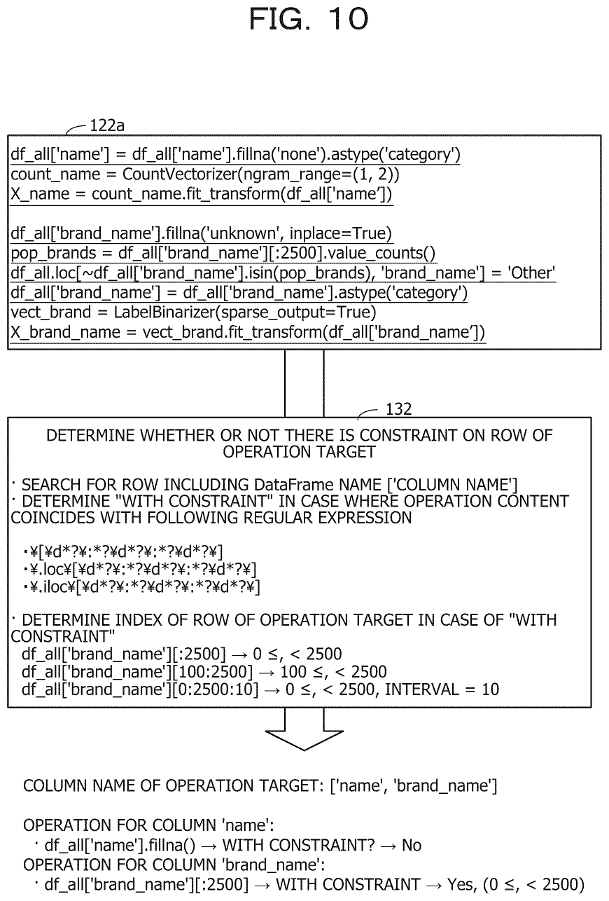

FIG. 10 is a diagram illustrating an example of the data sampling condition search. From the machine learning program 122a, the data sampling condition search unit 132 extracts an operation on data of an instance of pandas.DataFrame specified from a path extracted by the path extraction unit 131. For example, the data sampling condition search unit 132 acquires a DataFrame name of the instance of pandas.DataFrame. In a case of the machine learning program 122a, “df_all” indicated in an instance “df_all=pd.read_table(“data.tsv”)” of pandas. Data Frame is the DataFrame name.

The data sampling condition search unit 132 searches the machine learning program 122a for a row including a DataFrame name “‘column name’”. In the example illustrated in FIG. 10, a row for operating a column name “name” and a row for operating a column name “brand_name” are extracted. The operations extracted from the machine learning program 122a are underlined in FIG. 10.

For each of the extracted operations, the data sampling condition search unit 132 determines whether or not an index of a row of an operation target has a constraint. In a case where the index of the row of the operation target has a constraint, the operation target of the operation is constrained to data of the row of the index designated by the operation description. In a case where the index of the row of the operation target has a constraint, in order to perform dynamic slicing, it is desired that pieces of data of rows of all designated indices are included in sampling table data.

For example, the data sampling condition search unit 132 determines “with constraint” in a case where the operation content coincides with any of the following regular expressions.
¥[¥d*?¥:*?¥d*?¥:*?¥d*?¥]
¥.loc¥[¥d*?¥:*?¥d*?¥:*?¥d*?¥]
¥.iloc¥[¥d*?¥:*?¥d*?¥:*?¥d*?¥]

“¥” indicates a backslash. “d” indicates an arbitrary number. “*” indicates that an immediately preceding character is repeated 0 times or more. “?” indicates that there are 0 or one immediately preceding character. For example, the regular expression “[¥d*?¥:*?¥d*?¥:*?¥d*?¥]” coincides with a case where at most three numerical values divided by “:” are surrounded by a parenthesis symbol ([ ]). “Ioc” indicates that a specific value is extracted by designating a row name (index) or a column name. “iloc” indicates that a specific value is extracted by designating a row number or a column number.

The three numerical values which coincide with the regular expression indicate indices of rows of an operation target. In a case of “with constraint”, the row of the operation target is determined based on the three numerical values which coincide with the regular expression.

A first numerical value indicates an index (value of train_id) of a head row of the operation target. In a case where the index of the head row of the operation target is “0”, the first numerical value may be omitted. A second numerical value indicates an index of a row next to the last row of the operation target. A third numerical value indicates a row interval in a case where rows at a regular interval between the head row and the last row of the operation target are operated. For example, in a case of “df[0:10:5]”, among rows (indices “0” to “9”) in a range from a 0-th row to a row before a 10-th row, rows one by one at 5 rows (rows having the indices “0, 5”) are the operation targets.

For example, for “df_all[‘brand_name’][:2500]”, rows having indices equal to or more than “0” and less than “2500” are the operation targets. For “df_all[‘brand_name’][100:2500]”, rows having indices equal to or more than “100” and less than “2500” are the operation targets. For “df_all[‘brand_name’][0:2500:10]”, among rows having indices equal to or more than “0” and less than “2500”, rows at an interval of 10 rows from a row having the index “0” (0, 10, 20, . . . ) are the operation targets.

Since operation contents of an operation of “df_all[‘name’].fillna( )”, for example, in the machine learning program 122a do not coincide with any of the regular expressions described above, it is determined that there is no constraint. Since operation contents of an operation of “df_all[‘brand_name’][:2500]” coincide with the first regular expression described above, it is determined that there is a constraint. Rows of the operation target in this case are rows having row number equal to or more than “0” and less than “2500”.

In a case where the row of the operation target has a constraint, the data sampling condition search unit 132 generates a data sampling condition indicating constraint contents. The data sampling condition search unit 132 stores the generated data sampling condition in the data sampling condition accumulation unit 133.

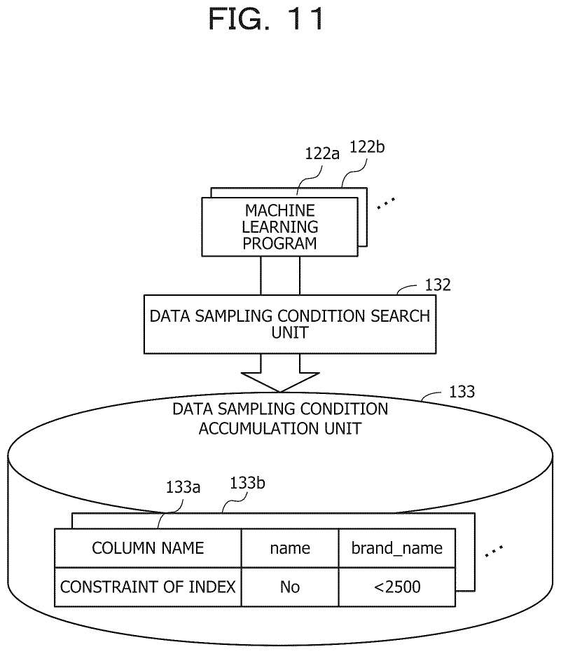

FIG. 11 is a diagram illustrating an example of a data sampling condition. The data sampling condition search unit 132 generates the data sampling conditions 133a, 133b, . . . corresponding to the plurality of machine learning programs 122a, 122b, . . . , respectively, and stores the data sampling conditions 133a, 133b, . . . in the data sampling condition accumulation unit 133.

For example, the data sampling condition 133a corresponding to the machine learning program 122a indicates that column names of columns storing data of the operation targets are “name” and “brand_name”. The data sampling condition 133a indicates that there is no constraint on an index of the row of the operation target for the column name “name”. The data sampling condition 133a further indicates that the column name “brand_name” has a constraint that the row of the operation target is a row having an index less than 2500. For example, in a case where the machine learning program 122a is executed, 2500 rows having the indices “0 to 2499” are desired to be input as the operation targets.

FIG. 12 is a flowchart illustrating an example of a procedure of a data sampling condition search process. Hereinafter, the processes illustrated in FIG. 12 will be described in order of operation numbers.

[operation S121] For each operation corresponding to a node of a path, the data sampling condition search unit 132 performs the processes in operations S122 to S127, sequentially from a high level of the path extracted by the path extraction unit 131. For example, when the number of rows of the path is L rows (L is a natural number), the processes in operations S122 to S127 are performed from the first row to the L-th row in order.

[operation S122] The data sampling condition search unit 132 determines whether or not a value is stored in the variable df. When the value is stored, the data sampling condition search unit 132 shifts the process to operation S124. When the value is not stored, the data sampling condition search unit 132 shifts the process to operation S123.

[operation S123] The data sampling condition search unit 132 stores a variable name of “DataFrame” in the variable df. For example, in a case of the path extracted from the dependency tree 31 illustrated in FIG. 8, “df_all” is stored in the variable df.

[operation S124] The data sampling condition search unit 132 determines whether or not the operation as a process target is an operation related to a column of DataFrame indicated by the variable df. In a case where the operation is related to the column of the corresponding Data Frame, the data sampling condition search unit 132 shifts the process to operation S125. In a case where the operation is not an operation related to the column of the corresponding DataFrame, the data sampling condition search unit 132 shifts the process to operation S128.

[operation S125] The data sampling condition search unit 132 acquires a column name from the operation as the process target. For example, the data sampling condition search unit 132 acquires a column name “name” when the operation as the process target is “df_all[‘name’]=df_all[‘name’].fillna(‘none’).astype(‘category’)”. The data sampling condition search unit 132 sets the acquired column name as a column name of a data sampling condition.

[operation S126] The data sampling condition search unit 132 determines whether or not there is a constraint on an index of a row of the process target of DataFrame indicated by the variable df. For example, the data sampling condition search unit 132 determines that “with constraint” in a case where a description indicating operation contents coincides with a predetermined regular expression. In a case where there is a constraint, the data sampling condition search unit 132 shifts the process to operation S127. In a case where there is no constraint, the data sampling condition search unit 132 shifts the process to operation S128.

[operation S127] The data sampling condition search unit 132 acquires the constraint on the index of the row of the process target indicated by the operation of the process target. For example, in a case of an operation “pop_brands=df_all[‘brand_name’][:2500].value_counts( )”, the data sampling condition search unit 132 acquires a constraint in which data of rows of “<2500” is included in sampling table data for the index the row of the process target. The data sampling condition search unit 132 associates the acquired constraint with a column name of the operation target, and sets the constraint as a data sampling condition.

[operation S128] After the process for the operations corresponding to all the nodes of the extracted path is ended, the data sampling condition search unit 132 ends the data sampling condition search process.

The data sampling condition is generated in this manner. After the data sampling condition is generated, the data sampling unit 134 performs data sampling on the table data 121, based on the data sampling conditions 133a, 133b, . . . for each of the machine learning programs 122a, 122b, . . . .

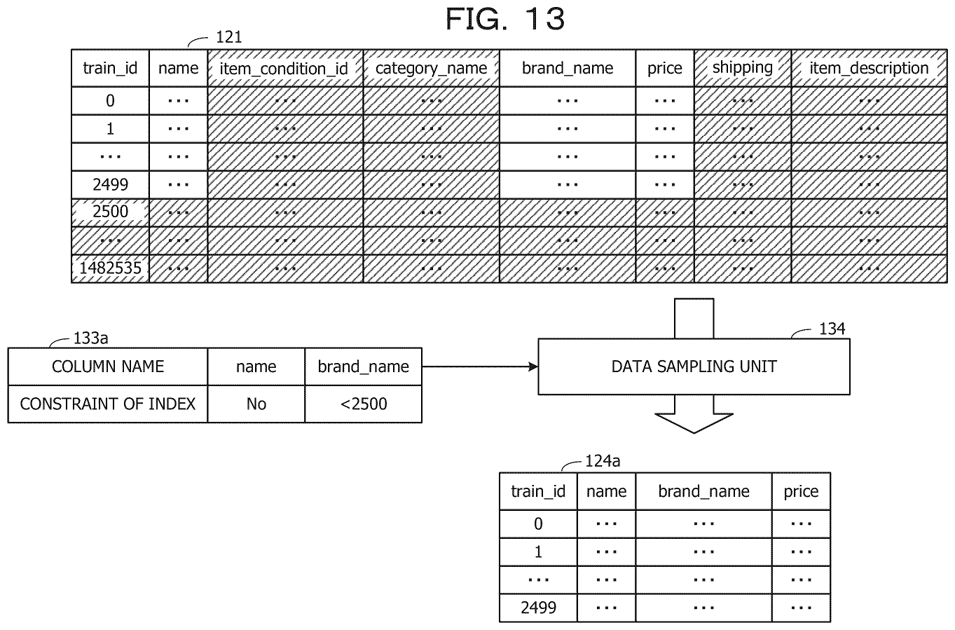

FIG. 13 is a diagram illustrating an example of data sampling. For example, the data sampling unit 134 extracts some pieces of data of the table data 121 based on the data sampling condition 133a, and generates the sampling table data 124a. As column names of operation targets, “name” and “brand_name” are set in the data sampling condition 133a illustrated in FIG. 13. As a constraint on an index of a row of the operation target, the data sampling condition 133a has a constraint in which, for the column name “brand_name”, data having indices “<2500” is included in the sampling table data 124a.

The data sampling unit 134 sets data in columns of “train_id”, “name”, “brand_name”, and “price” in the table data 121 as an extraction target. “train_id” is a column indicated by an index. “price” is a column designated by a target column name. “name” and “brand_name” are columns designated as the operation targets in the data sampling condition 133a.

Among the pieces of data of the columns of the extraction target, the data sampling unit 134 sets, as the extraction target, data of a row having an index designated in the constraint on the index of the row of the operation target. The data sampling unit 134 extracts data of the extraction target from the table data 121, and generates the sampling table data 124a including the extracted data of the extraction target.

The columns of “train_id”, “name”, “brand_name”, and “price” are provided in the sampling table data 124a. In the sampling table data 124a, data of 2500 rows having the indices “0 to 2499” are registered in each column.

FIG. 14 is a flowchart illustrating an example of a procedure of a data sampling process. Hereinafter, the processes illustrated in FIG. 14 will be described in order of operation numbers.

[operation S131] The data sampling unit 134 reads a data sampling condition corresponding to a machine learning program as a process target.

[operation S132] The data sampling unit 134 reads the table data 121.

[operation S133] From the table data 121, the data sampling unit 134 deletes data which does not satisfy the sampling condition. The data sampling unit 134 outputs the table data after deletion as sampling table data corresponding to the machine learning program as the process target.

In this manner, it is possible to generate the sampling table data 124a, 124b, . . . respectively corresponding to the machine learning programs 122a, 122b, . . . , by reducing the amount of data from the table data 121. The sampling table data 124a, 124b, . . . include minimum data for executing dynamic slicing on the corresponding machine learning programs 122a, 122b, . . . . Therefore, the dynamic slicing unit 140 may efficiently execute dynamic slicing on the machine learning programs 122a, 122b, . . . by using the sampling table data 124a, 124b, . . . . As a result, a process time of the dynamic slicing is reduced.

In a case of the example illustrated in FIG. 13, the amount of data is reduced to approximately 5% of a capacity of the original table data 121. As a result, it is possible to reduce an execution time of the dynamic slicing by approximately 30%.

With the second embodiment, the sampling table data 124a, 124b, . . . respectively optimized for the machine learning programs 122a, 122b, . . . are generated. Therefore, dynamic slicing for the machine learning programs 122a, 122b, . . . may be performed by using the sampling table data 124a, 124b, . . . including only minimum data.

### Third Embodiment

With a third embodiment, one sampling table data is generated for the plurality of machine learning programs 122a, 122b, . . . . By combining the sampling table data into one, the total data amount of the sampling table data may be reduced when dynamic slicing is collectively executed on the plurality of machine learning programs 122a, 122b, . . . . Hereinafter, different points of the third embodiment from the second embodiment will be described.

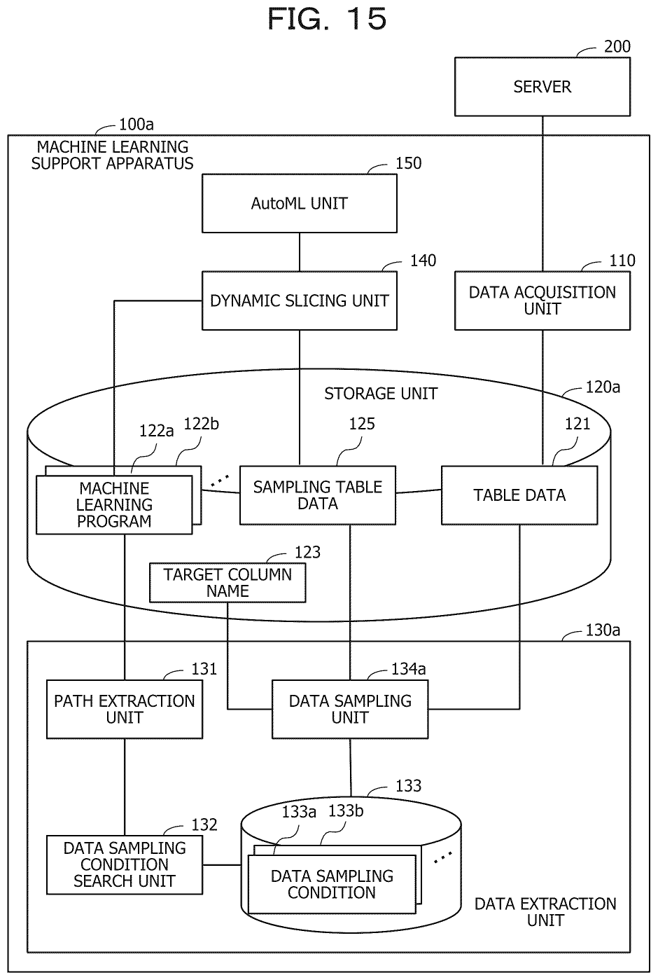

FIG. 15 is a block diagram illustrating an example of a function of a machine learning support apparatus according to the third embodiment. Among elements indicating a function of a machine learning support apparatus 100a in FIG. 15, elements similar to the elements in the second embodiment are denoted by the same reference signs as in the second embodiment, and the description thereof will be omitted.

A storage unit 120a of the machine learning support apparatus 100a according to the third embodiment stores sampling table data 125 generated for the plurality of machine learning programs 122a, 122b, . . . . A data sampling unit 134a in a data extraction unit 130a generates a data sampling condition that is a logical sum of the data sampling conditions 133a, 133b, . . . corresponding to the machine learning programs 122a, 122b, . . . , respectively. Based on the generated data sampling condition, the data sampling unit 134a extracts data from the table data 121, and generates the sampling table data 125.

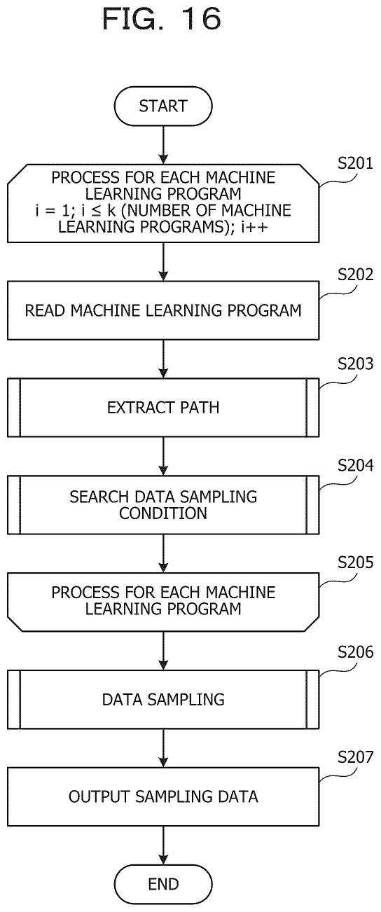

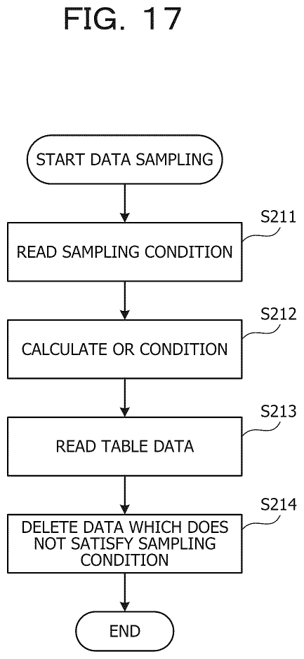

FIG. 16 is a flowchart illustrating an example of a procedure of a data extraction process according to the third embodiment. Hereinafter, the processes illustrated in FIG. 16 will be described in order of operation numbers.

[operation S201] The data extraction unit 130a executes the processes in operations S202 to S204 on each machine learning program.

[operation S202] The data extraction unit 130a reads one of the machine learning programs, on which the data extraction process is not executed, from the storage unit 120a.

[operation S203] The path extraction unit 131 of the data extraction unit 130a performs a path extraction process of extracting a path indicating a dependency relationship of a data process in the read machine learning program. Details of the path extraction process are as illustrated in FIG. 9.

[operation S204] Based on the path extracted by the path extraction unit 131, the data sampling condition search unit 132 performs a data sampling condition search process. Details of the data sampling condition search process are as illustrated in FIG. 12. By the data sampling condition search process, a data sampling condition for data sampling corresponding to the machine learning program as a process target is generated.

[operation S205] After the processes in operations S202 to S204 are completed for all the machine learning programs 122a, 122b, . . . , the data extraction unit 130a shifts the process to operation S206.

[operation S206] Based on the data sampling conditions 133a, 133b, . . . generated for the machine learning programs 122a, 122b, . . . , respectively, the data sampling unit 134a performs a data sampling process from the table data 121. Details of the data sampling process will be described below (see FIG. 17).

[operation S207] The data sampling unit 134a outputs the sampling table data 125 generated in the data sampling process. For example, the data sampling unit 134a stores the sampling table data 125 in the storage unit 120a.

FIG. 17 is a flowchart illustrating an example of a procedure of a data sampling process according to the third embodiment. Hereinafter, the processes illustrated in FIG. 17 will be described in order of operation numbers.

[operation S211] The data sampling unit 134a reads the data sampling conditions 133a, 133b, . . . corresponding to the plurality of machine learning programs 122a, 122b, . . . .

[operation S212] The data sampling unit 134a calculates an OR condition of the data sampling conditions 133a, 133b, . . . . The data sampling unit 134a generates a data sampling condition indicating the OR condition of the data sampling conditions 133a, 133b, . . . . For example, the data sampling unit 134a generates a data sampling condition in which data to be an extraction target in at least one of the data sampling conditions 133a, 133b, . . . is set as the extraction target.

[operation S213] The data sampling unit 134a reads the table data 121.

[operation S214] The data sampling unit 134a deletes data which does not satisfy the data sampling condition indicating the OR condition of the data sampling conditions 133a, 133b, . . . , from the table data 121. The data sampling unit 134a outputs the table data after deletion as the sampling table data 125 common to the plurality of machine learning programs 122a, 122b, . . . .

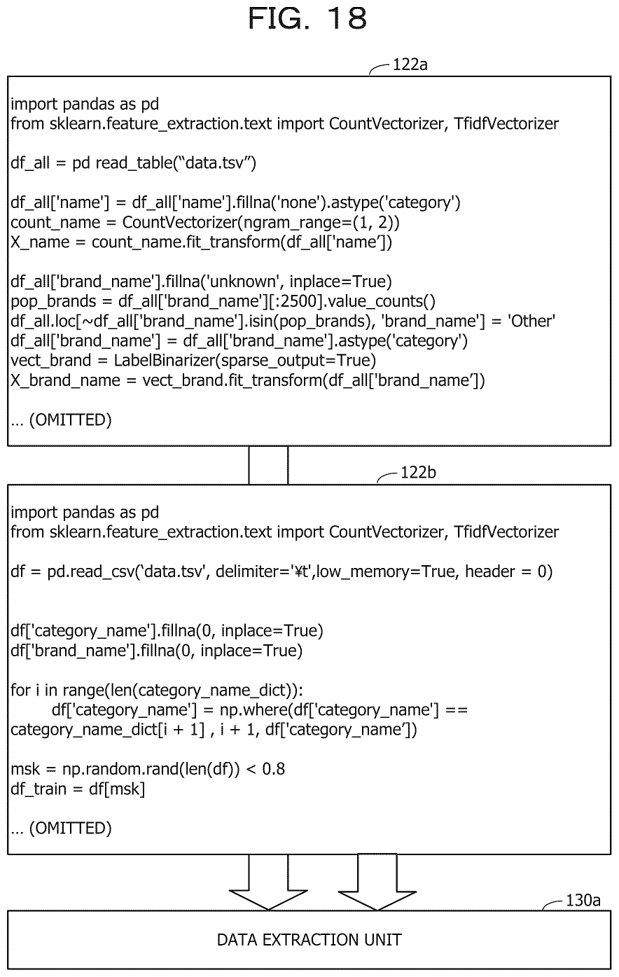

In this manner, one sampling table data 125 usable for dynamic slicing of the plurality of machine learning programs 122a, 122b, . . . is generated. Hereinafter, assuming a case where the sampling table data 125 corresponding to the two machine learning programs 122a and 122b is generated, a generation example of the sampling table data 125 will be described with reference to FIGS. 18 to 22.

FIG. 18 is a diagram illustrating an example of a machine learning program. For example, it is assumed that there are two machine learning programs 122a and 122b as illustrated in FIG. 18. Both of these machine learning programs 122a and 122b are programs for performing machine learning by using the table data 121 as inputs. The data extraction unit 130a reads these machine learning programs 122a and 122b from the storage unit 120a. The path extraction unit 131 performs a path extraction process on each of the machine learning programs 122a and 122b. Accordingly, a path indicating a dependency relationship of the data process is extracted. An instance of pandas.DataFrame is searched based on the extracted path, and a data frame name corresponding to each of the machine learning programs 122a and 122b is specified.

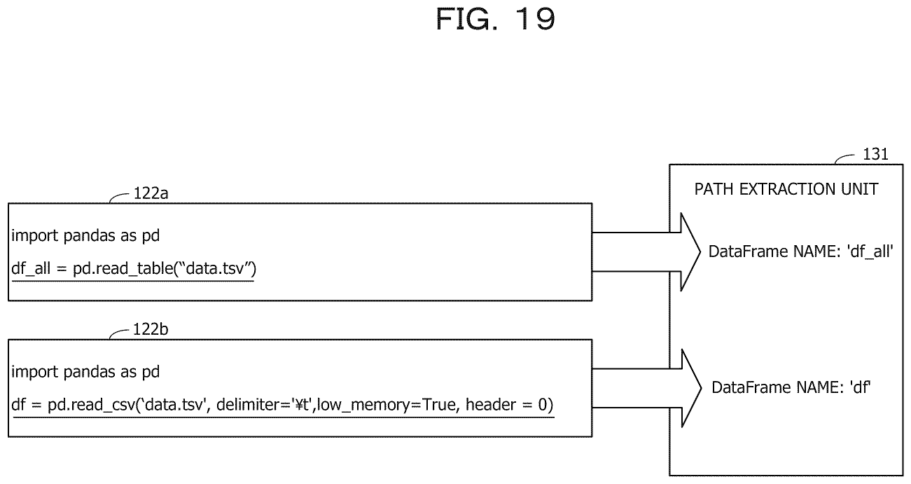

FIG. 19 is a diagram illustrating an example of a data frame name of each of a plurality of machine learning programs. For example, in the machine learning program 122a, it is seen that a data frame name of an operation target is “df_all”, based on “df_all=pd.read_table(“data.tsv”)”. In the machine learning program 122b, based on “df=pd.read_csv(‘data.tsv’, delimiter=‘t’, low_memory=True, header=0)”, it is seen that the data frame name of the operation target is “df”.

Next, the data sampling condition search unit 132 searches for a data sampling condition, for each of the machine learning programs 122a and 122b.

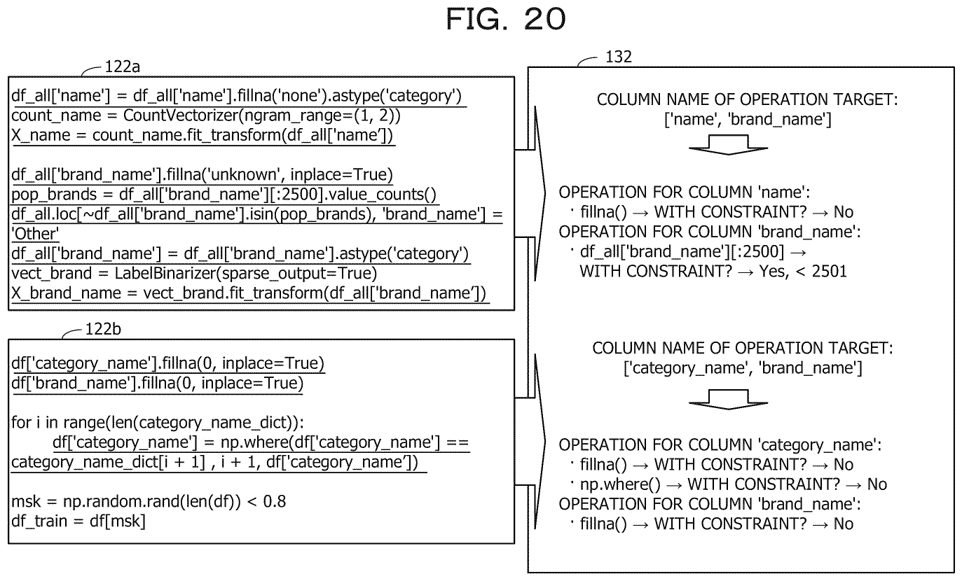

FIG. 20 is a diagram illustrating an example of the data sampling condition search for each of the plurality of machine learning programs. For the machine learning program 122a, in the same manner as the second embodiment, the data sampling condition 133a is generated such that columns of an operation target are “name” and “brand_name”, and indices of rows as the operation target are less than 2500 (<2500).

For the machine learning program 122b, the data sampling condition 133b is generated based on operations (indicated by an underline in FIG. 20) related to columns of a data frame. For example, columns of the operation target are specified as “category_name” and “brand_name” by searching for a row including a DataFrame name “‘column name’”.

A determination is made as to whether or not an operation content for data in the column coincides with a predetermined regular expression, and in a case where the operation content coincides with the predetermined regular expression, it is determined that there is a constraint on an index of a row as the operation target. In the example illustrated in FIG. 20, for both columns of “category_name” and “brand_name”, the operation content does not coincide with the predetermined regular expression, and it is determined that there is no constraint.

Based on the result of the data sampling condition search, the data sampling condition search unit 132 generates a data sampling condition for each of the plurality of machine learning programs 122a and 122b. The data sampling condition search unit 132 stores the generated data sampling condition in the data sampling condition accumulation unit 133. By the data sampling unit 134a, a data sampling condition that satisfies the OR condition of the data sampling conditions 133a and 133b generated for each of the machine learning programs 122a and 122b is generated.

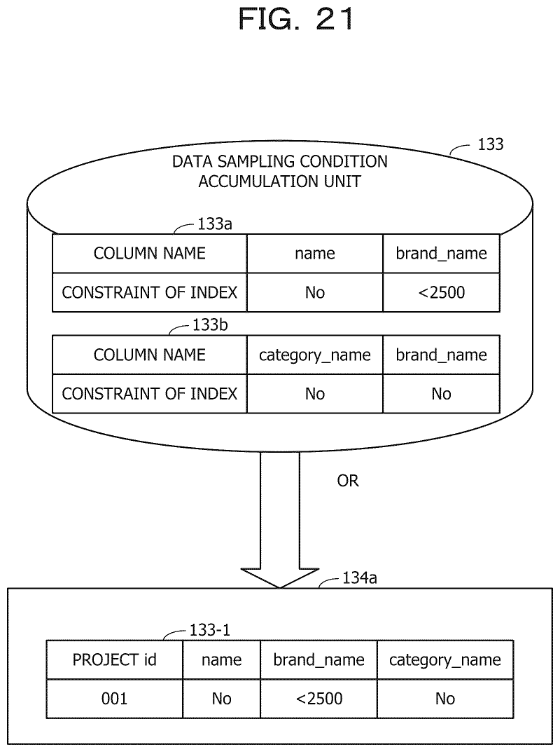

FIG. 21 is a diagram illustrating an example of a data sampling condition of each of the plurality of machine learning programs and an OR condition of the data sampling condition. The data sampling condition 133a corresponding to the machine learning program 122a and the data sampling condition 133b corresponding to the machine learning program 122b are stored in the data sampling condition accumulation unit 133. The data sampling unit 134a obtains an OR condition of the two data sampling conditions 133a and 133b, and generates an integrated data sampling condition 133-1.

A project id and a column name of a column as an operation target are set in the data sampling condition 133-1. For each column name, a constraint content of an index of a row of the operation target for the corresponding column is set. In the example illustrated in FIG. 21, there is no constraint on an index of a row of an operation target related to columns “name” and “category_name”. For the column of “brand_name”, there is a constraint in which data of a row having an index less than 2500 (<2500) is included.

Based on the data sampling condition 133-1, the data sampling unit 134a extracts data from the table data 121, and generates the sampling table data 125.

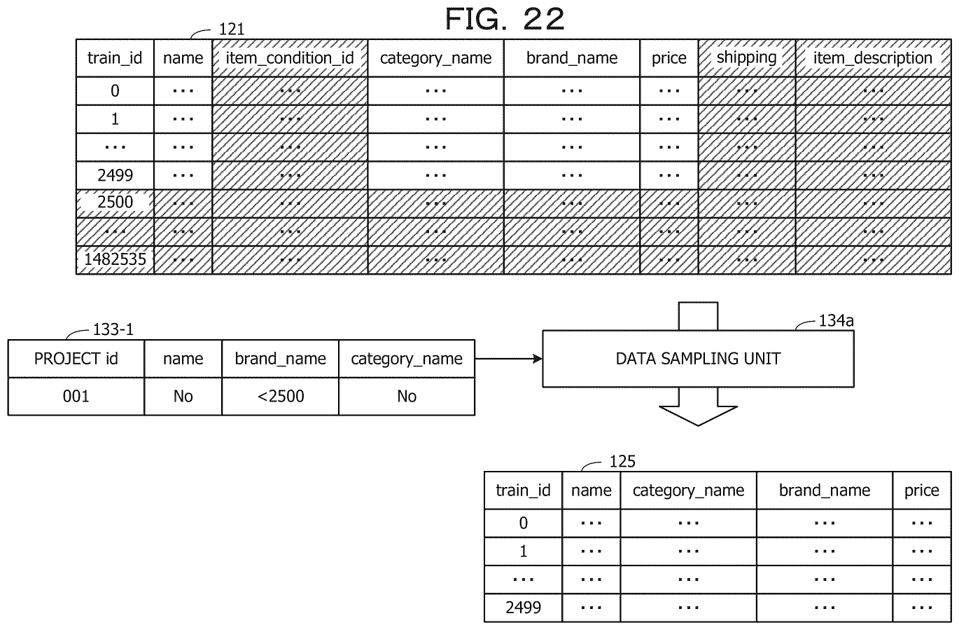

FIG. 22 illustrates an example of data sampling. For example, the data sampling unit 134a extracts some pieces of data of the table data 121 based on the data sampling condition 133-1, and generates the sampling table data 125. As column names of operation targets “name”, “brand_name”, and “category_name” are set in the data sampling condition 133-1 illustrated in FIG. 22. In the data sampling condition 133-1, as a constraint on an index of a row of the operation target, there is a constraint in which data having an index of “<2500” is included for the column name “brand_name”.

The data sampling unit 134a sets data of columns of “train_id”, “name”, “category_name”, “brand_name”, and “price” in the table data 121 as an extraction target. “train_id” is a column indicated by an index. “price” is a column designated by a target column name. “name”, “category_name”, and “brand_name” are columns designated as operation targets in the data sampling condition 133-1.

Among the pieces of data of the columns of the extraction target, the data sampling unit 134a sets, as the extraction target, data of a row having an index designated in the constraint on the index of the row of the operation target. The data sampling unit 134a extracts data of the extraction target from the table data 121, and generates the sampling table data 125 including the extracted data of the extraction target.

The columns of “train_id”, “name”, “category_name”, “brand_name”, and “price” are provided in the sampling table data 125. In the sampling table data 125, data of 2500 rows having the indices “0 to 2499” are registered in each column.

By using such sampling table data 125, it is possible to execute dynamic slicing of each of the two machine learning programs 122a and 122b. The data amount of the sampling table data 125 is reduced from the table data 121, and a time taken for the dynamic slicing is reduced. As compared with a case where sampling data is generated for each of the machine learning programs 122a and 122b, the entire data amount is reduced since one sampling table data 125 is generated for the plurality of machine learning programs 122a and 122b.

By using only one sampling table data 125, the sampling table data 125 may be read into the memory 102 only once in a case where dynamic slicing of the machine learning programs 122a and 122b is continuously executed. As a result, the dynamic slicing of the machine learning programs 122a and 122b becomes efficient.

With the third embodiment, a data extraction process time from the table data 121 is reduced. For example, in the second embodiment, as many pieces of sampling table data as the number of machine learning programs are prepared. Therefore, the number of steps of the data sampling process is increased in proportion to the number of machine learning programs. By contrast, with the third embodiment, the data sampling process is performed only once, regardless of the number of machine learning programs. Therefore, the data extraction process time may be reduced.

As compared with the individual sampling table data 124a, 124b, . . . optimized for each machine learning program as in the second embodiment, the data amount of the sampling table data 125 according to the third embodiment may be large. Meanwhile, the variety of data operations in tasks to which the same table data is input is not generally large. Therefore, as compared with the individually optimized sampling table data 124a, 124b, . . . , it is unlikely that the data amount of the sampling table data 125 will be significantly increased.

### Other Embodiments

In some cases, learning data and test data are used as input data in a machine learning program. For example, in the machine learning program, DataFrame in which a plurality of pieces of table data are combined is defined.

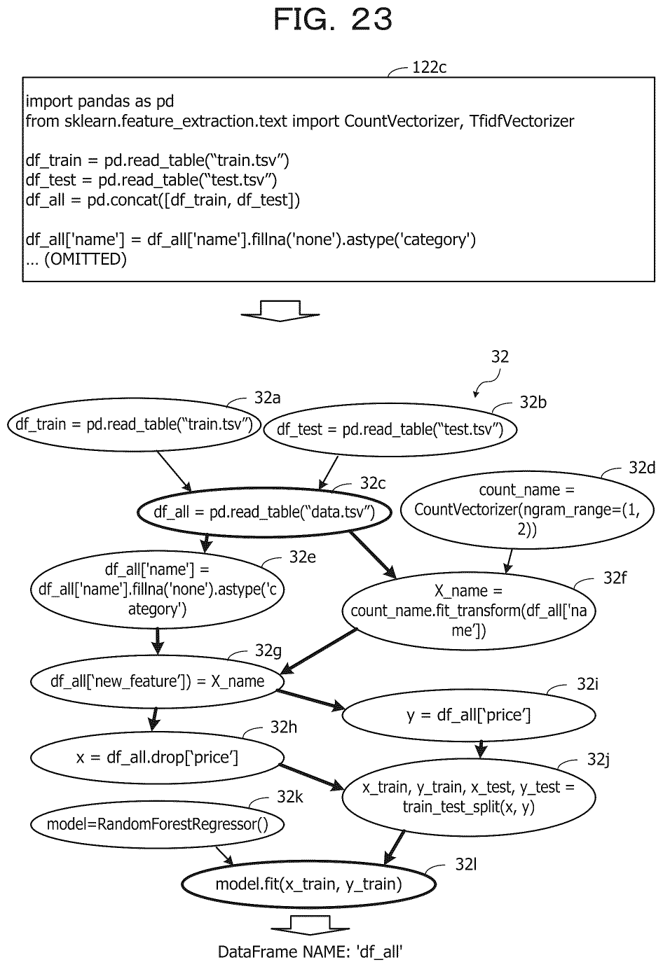

FIG. 23 is a diagram illustrating an example of a machine learning program in which a plurality of pieces of table data are set as input data. A machine learning program 122c uses learning table data “train.tsv” and test table data “test.tsv” as the input data. The two pieces of table data are coupled by a concat function, and combined in one DataFrame “df_all”. A process for the data in the DataFrame “df_all” in the machine learning program 122c has the same manner as the machine learning program 122a described in the second embodiment.

In this case, a dependency tree 32 generated based on the machine learning program 122c has three nodes 32a to 32c, in addition to nodes 32d to 321 respectively corresponding to the nodes 31b to 31j of the dependency tree 31 of the machine learning program 122a. The nodes 32a and 32b are definitions of DataFrame of each of the two pieces of input data. The node 32c is a definition of DataFrame of data obtained by coupling the two pieces of input data.

For searching for an instance of pandas.DataFrame based on the dependency tree 32, the data sampling condition search unit 132 traces a dependency relationship from the node 321 indicating data (x_train, y_train) used for learning upward (thick line arrow).

In a case where the input is divided into train and test and train and test are coupled (concat), the search is ended when reaching the node 32c to be coupled. For example, in a case where both of the following two conditions are satisfied, the data sampling condition search unit 132 ends the search. Two or more nodes are coupled to an upper level of a coupled node. The nodes at the upper level of the coupled node are not traced any more.

In the example illustrated in FIG. 23, the two nodes 32a and 32b exist at an upper level than the node 32C to which the nodes 32a and 32b are coupled, and all of the nodes are not traced upward. In such a case, the search for pandas.DataFrame is ended at the node 32c, and the pandas.DataFrame name “df_all” indicated at the node 32c is specified as an operation target.

In a case where the input data is learning table data and evaluation table data, the data sampling unit 134 extracts sampling data from the learning table data. In this case, the data sampling unit 134 may determine the table data for learning, for example, based on data sizes of the two pieces of input data. For example, the data sampling unit 134 determines that the input data having a larger size is the learning table data.

The data sampling unit 134 may determine the learning table data based on a file name. For example, the data sampling unit 134 determines that table data having a name including “train” is the learning table data.

Alternatively, in a case where a name of table data includes “test” or “validation”, the data sampling unit 134 determines that the table data is the evaluation table data. Even when it may not be clearly determined that the table data is the learning table data or the evaluation table data based on the name, the data sampling unit 134 may determine whether or not the other table data is the learning table data or the evaluation table data.

Hereinbefore, the embodiments are exemplified, the configuration of each unit described in the embodiment may be replaced with another unit having the same function. Arbitrary another component or step may be added. Arbitrary two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an output program causing a computer to execute a process, the process comprising:
extracting an operation description related to a data operation for input data to a machine learning program, from the machine learning program;
determining an extraction condition of target data to be operated in the data operation, based on the extracted operation description;
extracting the target data which satisfies the determined extraction condition, from the input data; and
outputting sampling data which includes the extracted target data.

2. The non-transitory computer-readable recording medium according to claim 1,
wherein, in the determining of the extraction condition, a column name of a column, in which the target data is stored, in the input data in a table format is specified from the extracted operation description, and a condition in which the target data is stored in a column of the specified column name is included in the extraction condition.

3. The non-transitory computer-readable recording medium according to claim 2,
wherein, in the determining of the extraction condition, a condition in which the target data is stored in the column of the specified column name of a row which corresponds to an index designated in the extracted operation description is included in the extraction condition.

4. The non-transitory computer-readable recording medium according to claim 1,
wherein, in the extracting of the target data, non-target data which does not satisfy the extraction condition is deleted from the input data.

5. The non-transitory computer-readable recording medium according to claim 1,
wherein, in the extracting of the target data, the target data which satisfies the determined extraction condition and label data to be predicted in machine learning which uses the machine learning program are extracted from the input data, and
wherein, in the outputting of the sampling data, the sampling data which includes the extracted target data and the label data is output.

6. The non-transitory computer-readable recording medium according to claim 1,
wherein, in the extracting of the operation description, the operation description for the input data common to a plurality of machine learning programs is extracted from each of the plurality of machine learning programs, the plurality of machine learning programs including the machine learning program,
wherein, in the determining of the extraction condition, the extraction condition is determined for each of the plurality of machine learning programs, and
wherein, in the extracting of the target data, the target data which satisfies any one of a plurality of extraction conditions which correspond to the plurality of machine learning programs is extracted from the input data, the plurality of extraction conditions including the extraction condition.

7. An output method causing a computer to execute a process, the process comprising:
extracting an operation description related to a data operation for input data to a machine learning program, from the machine learning program;
determining an extraction condition of target data to be operated in the data operation, based on the extracted operation description;
extracting the target data which satisfies the determined extraction condition, from the input data; and
outputting sampling data which includes the extracted target data.

8. An information processing apparatus comprising:
a memory; and
a processor coupled to the memory and configured to:
extract an operation description related to a data operation for input data to a machine learning program, from the machine learning program;
determine an extraction condition of target data to be operated in the data operation, based on the extracted operation description;
extract the target data which satisfies the determined extraction condition, from the input data; and
output sampling data which includes the extracted target data.
